(19) United States
(12) Patent Application Publication
(10) Pub. No.: US 2013/0177191 A1
(43) Pub. Date: Jul. 11, 2013

(54) AUDIO RECORDER

(71) Applicants: Toshihiro Waguri, Hyogo (JP); Hitoshi Miyamoto, Osaka (JP); Atsushi Yamada, Osaka (JP); Yasushi Obata, Osaka (JP); Hiroyuki Kinemura, Hyogo (JP); Hiroyoshi Sato, Osaka (JP)

(72) Inventors: Toshihiro Waguri, Hyogo (JP); Hitoshi Miyamoto, Osaka (JP); Atsushi Yamada, Osaka (JP); Yasushi Obata, Osaka (JP); Hiroyuki Kinemura, Hyogo (JP); Hiroyoshi Sato, Osaka (JP)

(73) Assignee: SANYO ELECTRIC CO., LTD., Moriguchi-shi, Osaka (JP)

(21) Appl. No.: 13/825,016

(22) PCT Filed: Feb. 14, 2012
(86) PCT No.: PCT/JP2012/053406

§ 371 Date: Mar. 18, 2013

(30) Foreign Application Priority Data
Mar. 11, 2011 (JP) 2011-053945

(51) Int. Cl. H04R 1/08

(52) U.S. Cl. CPC H04R 1/08
USPC 381/356

(57) ABSTRACT

An audio recorder having a plurality of microphones including at least a first microphone and a second microphone provided in a first housing and a second housing, respectively, at least one of the first housing and the second housing being rotatably supported, and having an audio recording function in a set prescribed audio recording mode, in which the first housing and the second housing are arranged vertically one above the other, and the audio recorder has means for setting a prescribed audio recording mode in accordance with a relative position of the first microphone and the second microphone. According to this audio recorder, the prescribed audio recording mode is set in accordance with the relative position of the first housing and the second housing. Thus, a desired audio recording mode can be set more intuitively by a user.

### TECHNICAL FIELD

The present invention relates to an audio recorder having a plurality of microphones.

### BACKGROUND ART

An image pick-up apparatus described in Japanese Patent Laying-open No. 2001-296343 (PTL 1) is an example of conventional audio recorders having a plurality of microphones. This image pick-up apparatus is utilized in a video conference system and the like, and records the voice from a desired sound source by moving the plurality of microphones.

### CITATION LIST

### Patent Literature

PTL 1: Japanese Patent Laying-open No. 2001-296343 (GO1S 3/808)

### SUMMARY OF INVENTION

### Technical Problem

The image pick-up apparatus disclosed in PTL 1 includes two sets of microphones provided in a first housing and a second housing arranged vertically with rotation means interposed therebetween. The movement of the microphone set provided in the first housing can be controlled so that the directivity of the microphone set is correctly turned toward a sound source such as a speaker. The movement of the microphone set provided in the second housing cannot be controlled, however. Moreover, a user has to perform complicated operation with regard to the setting of each microphone for audio recording. Furthermore, the setting has a low degree of freedom.

The present invention solves such problems as described above, and an object of the present invention is to provide an audio recorder in which a desired audio recording manner can be set with more intuitive operation by a user.

### Solution to Problem

An audio recorder according to the present invention includes a first housing and a second housing which are arranged vertically one above the other, at least one of them being rotatably supported, a plurality of microphones which include a first microphone and a second microphone provided in the first housing and the second housing, respectively, and a control unit which sets a prescribed audio recording mode in accordance with a relative position of the first microphone and the second microphone, and enables an audio recording function in the set audio recording mode.

According to this audio recorder, a prescribed audio recording mode is set in accordance with a relative position of the first housing and the second housing. Thus, a desired audio recording mode can be set more intuitively by a user.

According to an aspect of this audio recorder, the plurality of microphones include a third microphone provided in the first housing diagonally to the first microphone, and a fourth microphone provided in the second housing diagonally to the second microphone, when at least one of the first housing and the second housing is rotated so that one of the first microphone and the third microphone and one of the second microphone and the fourth microphone are arranged vertically one above the other, the one of the first microphone and the third microphone and the other of the second microphone and the fourth microphone have directivities in opposite directions, and when at least one of the first housing and the second housing is rotated so that a first diagonal line connecting the first microphone to the third microphone is substantially orthogonal to a second diagonal line connecting the second microphone to the fourth microphone, the first microphone, the second microphone, the third microphone and the fourth microphone have directivities in directions different from one another.

According to this audio recorder, the directivity for picking up sound is changed by the rotation of the first housing and/or the second housing. Thus, a desired directivity can be attained more readily by the user.

According to an aspect of this audio recorder, the first microphone is arranged in the vicinity of a side surface of the first housing, the audio recorder further includes a first sensor provided on a top surface of the first housing, and in the vicinity of the first microphone, and when detection is made by the first sensor, the control unit enables a function of turning off one of the microphones arranged diagonally to the first microphone, or reducing noise contained in an audio signal output from the first microphone based on an audio signal output from the diagonally arranged microphone.

According to this audio recorder, the user can, by specifying a sensor, for example, use one of the microphones arranged diagonally to the sensor that has made the detection in order to reduce noise. Thus, an audio signal from a desired microphone can be heard more clearly.

According to an aspect of this audio recorder, the audio recorder further includes a third sensor and a fourth sensor provided on the top surface of the first housing, in which when at least one of the first housing and the second housing is rotated so that the second diagonal line is substantially orthogonal to the first diagonal line, the third sensor and the fourth sensor are provided on the second diagonal line, when detection is made by the third sensor, the control unit enables a function of turning off one of the microphones arranged diagonally to one of the microphones arranged in the vicinity of the third sensor, or reducing noise contained in an audio signal output from the microphone arranged in the vicinity of the third sensor based on an audio signal output from the diagonally arranged microphone, and when detection is made by the fourth sensor, the control unit enables a function of turning off one of the microphones arranged diagonally to one of the microphones arranged in the vicinity of the fourth sensor, or reducing noise contained in an audio signal output from the microphone arranged in the vicinity of the fourth sensor based on an audio signal output from the diagonally arranged microphone.

According to an aspect of this audio recorder, the audio recorder further includes a light-emitting unit provided on a top surface of the first housing, which indicates states of the plurality of microphones.

According to this audio recorder, the states of the microphones can be seen at a glance, allowing more intuitive operation by the user.

According to an aspect of this audio recorder, the audio recorder further includes a speaker provided on a top surface of the first housing, which outputs recorded sound in the vicinity of a rotation axis.

### Advantageous Effects of Invention

According to the audio recorder of the present invention, a desired audio recording manner can be set with more intuitive operation by a user.

### BRIEF DESCRIPTION OF DRAWINGS

FIG. 1 is a perspective view of an IC recorder according to an embodiment of the present invention.

FIG. 2 is another perspective view of the IC recorder according to the embodiment of the present invention.

FIG. 3 is another perspective view of the IC recorder according to the embodiment of the present invention.

FIG. 4 is an external view showing part of the appearance of the IC recorder according to the embodiment of the present invention.

FIG. 5 is a circuit diagram showing part of a circuit in the IC recorder according to the embodiment of the present invention.

FIG. 6 is a diagram showing part of a table stored by the IC recorder according to the embodiment of the present invention.

FIG. 7 is a diagram illustrating a first state of the IC recorder according to the embodiment of the present invention.

FIG. 8 is another diagram illustrating the first state of the IC recorder according to the embodiment of the present invention.

FIG. 9 is a diagram illustrating a second state of the IC recorder according to the embodiment of the present invention.

FIG. 10 is another diagram illustrating the second state of the IC recorder according to the embodiment of the present invention.

FIG. 11 is a flowchart showing part of operation of the IC recorder according to the embodiment of the present invention.

FIG. 12 is a flowchart showing another part of operation of the IC recorder according to the embodiment of the present invention.

FIG. 13 is a flowchart subsequent to the flowchart showing another part of operation of the IC recorder according to the embodiment of the present invention.

FIG. 14 is a flowchart subsequent to the flowchart showing another part of operation of the IC recorder according to the embodiment of the present invention.

### DESCRIPTION OF EMBODIMENTS

An embodiment of an audio recorder according to the present invention will be specifically described below with reference to the drawings. In this embodiment, an audio recording device of the present invention is implemented as an IC (Integrated Circuit) recorder. The same or corresponding parts are designated with the same reference signs in the drawings, and descriptions thereof will not be repeated.

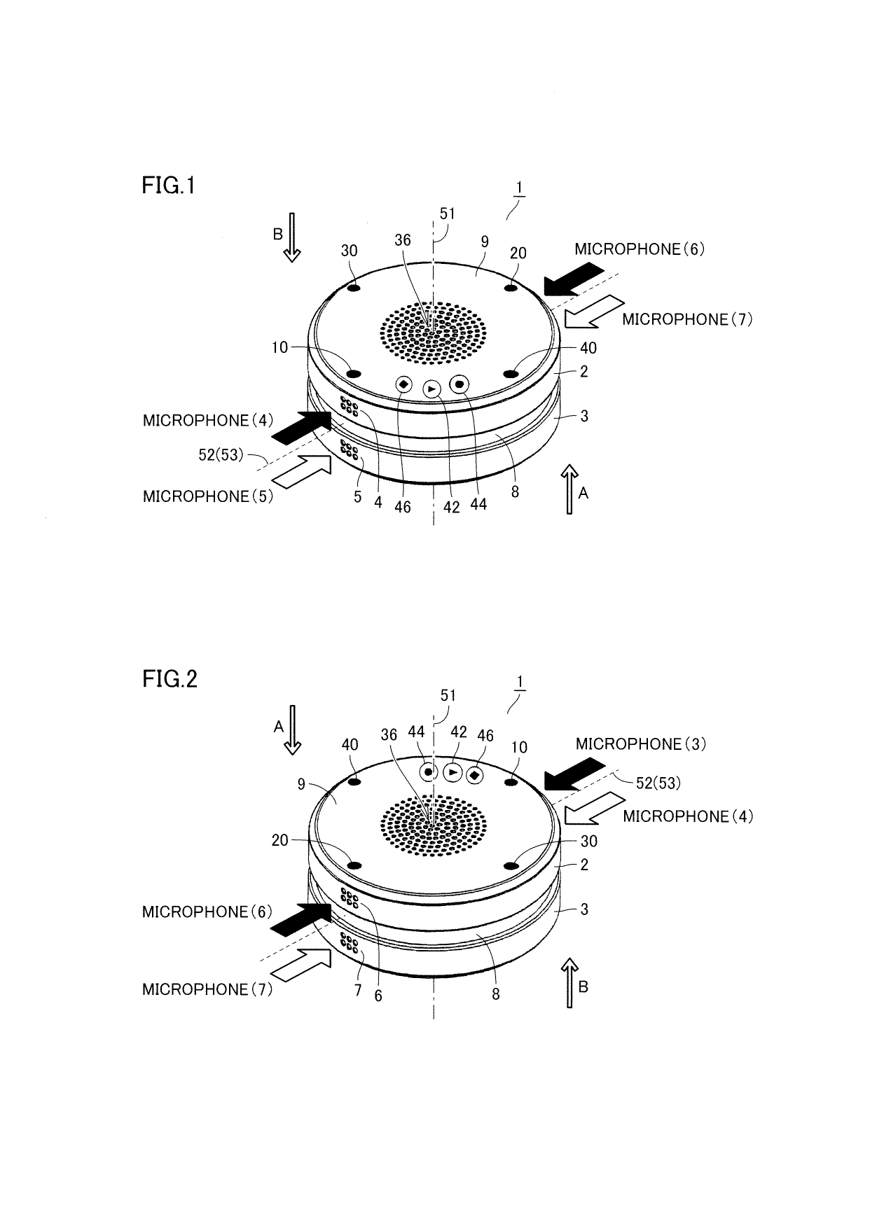

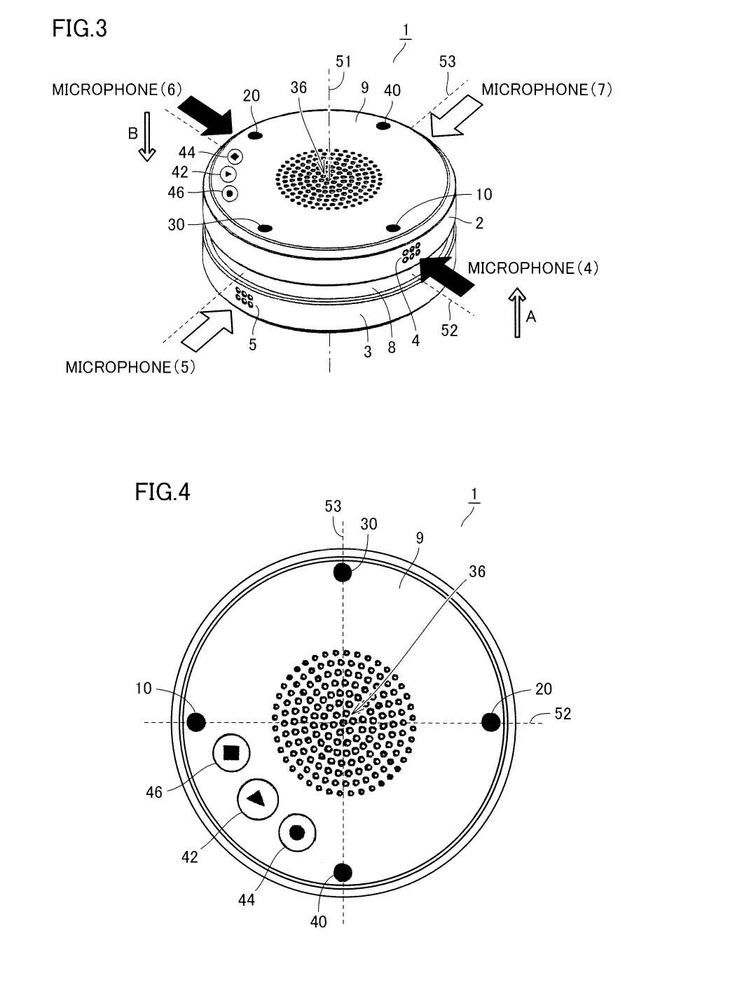

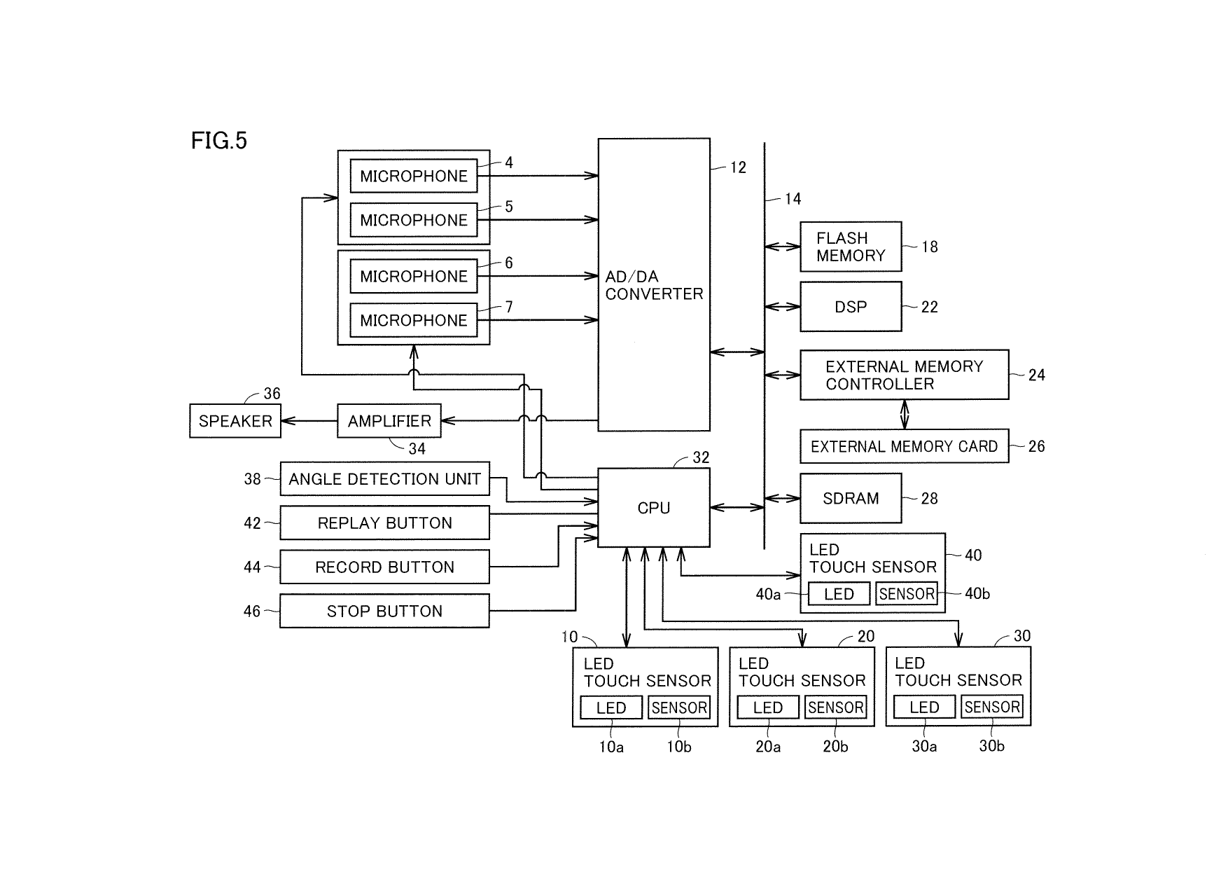

FIGS. 1 and 3 are perspective views of an IC recorder (1) according an embodiment of the present invention, as seen in a direction of an arrow A, FIG. 2 is a perspective view of the IC recorder (1), as seen in a direction of an arrow B, and FIG. 4 is a perspective view of the IC recorder (1), as seen from above.

The IC recorder (1) includes a first housing (2) and a second housing (3). The first housing (2) and the second housing (3) are arranged vertically one above the other with an intermediate member (8) interposed therebetween. The first housing (1) is provided on the second housing (3). Each of the first housing (2) and the second housing (3) is a cylindrical housing. A microphone (4) and a microphone (6) are provided to communicate the outside of the first housing (2) via an outer circumferential side surface which is in contact with the circumference of a top surface (9) of the first housing (2), and to be positioned above a diameter line (52) passing through the center of the first housing (2). Likewise, a microphone (5) and a microphone (7) are provided to communicate the outside of the second housing (3) via an outer circumferential side surface of the second housing (3), and to be positioned above a diameter line (53) passing through the center of the second housing (3). The diameter line (52) corresponds to a diagonal line connecting the microphone (4) to the microphone (6). The diameter line (53) corresponds to a diagonal line connecting the microphone (5) to the microphone (7).

The first housing (2) can rotate 90 degrees counterclockwise about a central axis (51) of the first housing (2) serving as a rotation axis. A state where the microphone (4) and the microphone (5) are arranged vertically (perpendicularly to the top surface (9) of the first housing (2)), as shown in FIGS. 1 and 2, is defined as a first state. A state where the microphone (4) and the microphone (5) are positioned relative to each other to form an angle of 90 degrees, as shown in FIG. 3, is defined as a second state. In the first state, the diameter line (52) is superimposed on the diameter line (53). In the second state, the diameter line (52) is orthogonal to the diameter line (53).

Although the first housing (2) is configured to be rotatable in this embodiment, the second housing (3) may alternatively be rotatable, or both of the first housing (2) and the second housing (3) may be rotatable. If rotatable, the second housing (3) rotates clockwise about the central axis (51) of the second housing (3) serving as a rotation axis.

The intermediate member (8) includes a first stopper and a second stopper which are not shown. The first stopper prohibits clockwise rotation of the first housing (2) in the first state shown in FIGS. 1 and 2. The second stopper prohibits counterclockwise rotation of the first housing (2) in the second state shown in FIG. 3. Namely, the first housing (2) is configured not to rotate more than 90 degrees relative to the second housing (3).

As shown in FIG. 4, the top surface (9) of the first housing (2) is provided with LED (Light Emitting Diode) touch sensors (10), (20), (30), (40), a replay button (42), a record button (44) and a stop button (46). When these sensors and buttons are touched or pressed, various operations are performed in the IC recorder (1). A speaker (36) is further provided around the center of the first housing (2), to communicate the outside of the housing via the top surface (9).

An electrical configuration of the IC recorder (1) in this embodiment will now be described with reference to FIG. 5.

The IC recorder (1) includes the directional microphones (4), (5), (6), (7). A CPU (Central Processing Unit) (32) controls the entire IC recorder (1). The CPU (32) is connected to a bus (14). The bus (14) is connected to an AD/DA converter (12), a flash memory (18), a DSP (Digital Signal Processor) (22), an external memory controller (24) and an SDRAM (Synchronous Dynamic Random Access Memory) (28). The flash memory (18) stores programs to be executed by the CPU (32), parameters for executing the programs, and the like. The CPU (32) is connected to the microphones (4), (5), (6), (7), the LED touch sensors (10), (20), (30), (40), an amplifier (34), an angle detection unit (38), the replay button (42), the record button (44) and the stop button (46).

The IC recorder (1) in this embodiment includes “dictation mode,” “conference mode,” “conversation mode,” “music mode” and “favorite mode” as audio recording modes. One of the modes is selected by a user's selection, or in accordance with the state of the rotated first housing (1). When “dictation mode” is selected, for example, the IC recorder (1) automatically sets audio recording parameters suitable for a dictation scene. When “conference mode” is selected, the IC recorder (1) automatically sets audio recording parameters suitable for a conference scene. When “conversation mode” is selected, the IC recorder (1) automatically sets audio recording parameters suitable for a conversation scene. When “music mode” is selected, the IC recorder (1) automatically sets audio recording parameters suitable for a music scene. When “favorite mode” is selected, the IC recorder (1) automatically sets audio recording parameters predetermined by the user.

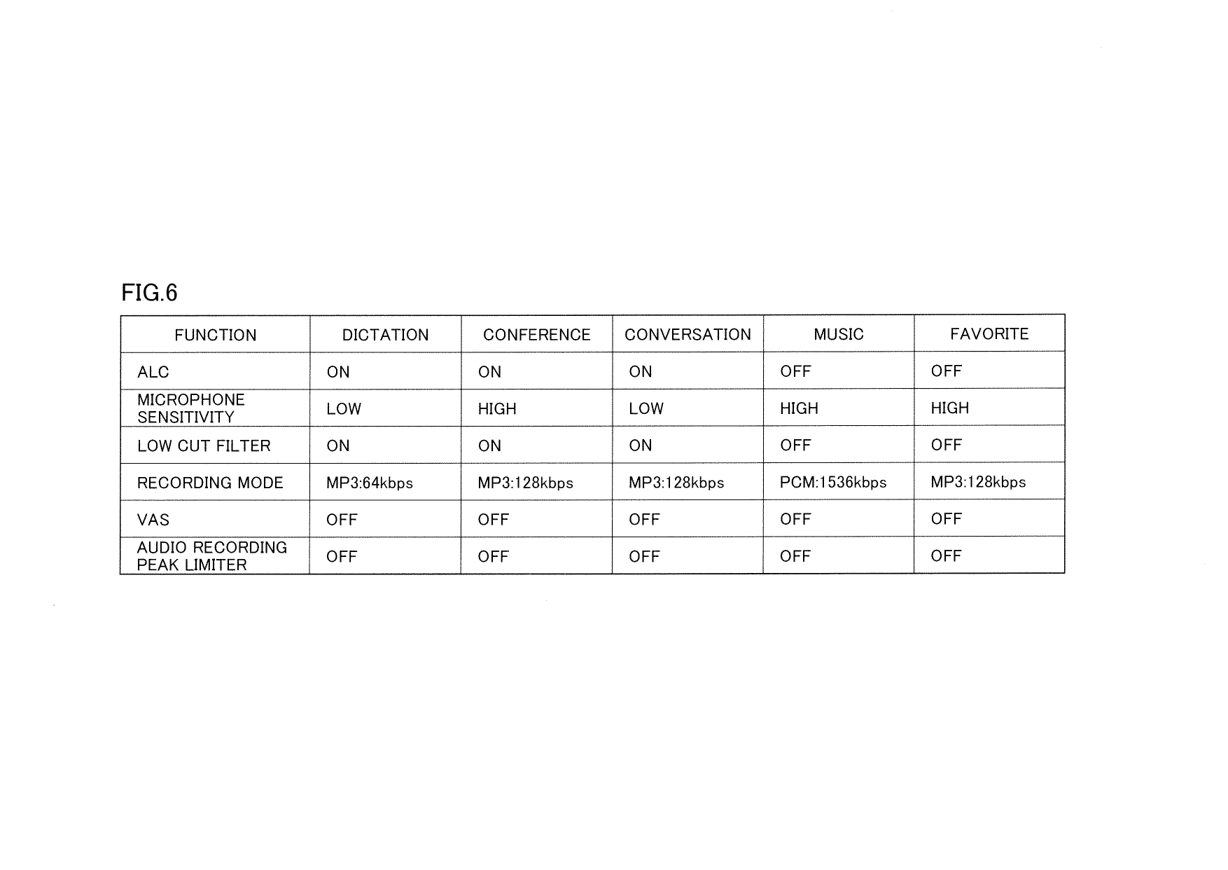

The audio recording parameters include ALC (automatic level control), microphone sensitivity, a low cut filter, a recording mode, a VAS (Voice Active System), and an audio recording peak limiter. Set values for these parameters are stored in the flash memory (18) as a corresponding table indicating relation with each mode, as shown in FIG. 6.

The DSP (22) performs the ALC function, and the functions of the recording mode and the audio recording peak limiter. The CPU (32) provides instructions to the DSP (22) by referring to the correspondence table, and the DSP (22) performs each process based on the set values for the audio recording parameters corresponding to each mode. The DSP (22) also has the function of performing a noise canceling process. The DSP (22) converts a digital audio signal, which is picked up by any one or more of the microphones (4), (5), (6), (7) that is set as a noise canceling microphone, and is input via the AD/DA converter (12), to an antiphase signal, to generate a canceling signal. In order to reduce noise in a digital audio signal, which is picked up by any one or more of the microphones (4), (5), (6), (7) that is set as an audio pickup microphone, and is input via the AD/DA converter (12), the DSP (22) mixes the generated canceling signal into the digital audio signal that has been subjected to various processes. This process is defined as the noise canceling process.

The CPU (32) switches the microphone sensitivity and performs the VAS function, and performs each process based on the set values for the functions corresponding to each mode.

The functions will be described. The ALC function is the function of adjusting the input level of a digital audio signal to be processed. The low cut filter function is the function of cutting low band sound in a digital audio signal to be processed. The recording mode function is the function of recording audio data using a compression format (or a non-compression format) and a bit rate in accordance with the set mode. The VAS function is the function of pausing recording at the occurrence of a silent state. The audio recording peak limiter function is the function of limiting the input level of a digital audio signal to be processed to be equal to or less than a prescribed value.

When the record button (44) is pressed, audio recording is started. Prior to the start of audio recording, the user can selectively set any one or more the microphones (4), (5), (6), (7) as an audio pickup microphone (ON state), and can selectively designate any one or more the microphones as a noise canceling microphone. A microphone that is not set as a noise canceling microphone may be set as an audio pickup microphone.

The sound picked up by all the microphones or the selected microphone(s) is output as an analog audio signal, and input to the AD/DA converter (12) connected to the microphones (4), (5), (6), (7). The AD/DA converter (12) converts the input analog audio signal to a digital audio signal.

The digital audio signal obtained by the AD/DA converter (12) is input to the DSP (22), and subjected to a process in accordance with the set mode, the canceling process, and various other processes.

The processed digital audio signal is temporarily stored in the SDRAM (28). The DSP (22) reads the digital audio signal stored in the SDRAM (28), processes the digital audio signal using a compression format (non-compression format) and a bit rate in accordance with the set mode, and temporarily stores the processed audio signal as audio data in the SDRAM (28). Then, the CPU (32) controls the external memory controller (24), to start recording the audio data stored in the SDRAM (28) onto an external memory card (26). When the stop button (46) is pressed, the audio recording ends. The recorded audio data is recorded as an audio file on the external memory card (26). In this embodiment, the process between the sound pickup by the microphones and the recording on the external memory card (26) is defined as audio recording.

The user specifies a desired audio file from the plurality of audio files recorded on the external memory card (26). When the replay button (42) is pressed, a replay of the specified audio file is started.

The control by the CPU (32) causes the audio file to be temporarily stored in the SDRAM (28) from the external memory card (26). The DSP (22) performs various processes for a replay such as an expansion process on the audio file, and the processed audio file is output as a digital audio replay signal to the AD/DA converter. The digital audio replay signal is converted to an analog replay signal by the AD/DA converter (12), and the analog replay signal is output to the amplifier (34). The amplifier (34) adjusts the gain of the analog replay signal, and then outputs the analog replay signal to the speaker (36). The speaker (36) outputs the analog replay signal as sound. When the stop button (46) is pressed, the replay ends. In this embodiment, the process between the temporal storing of the audio file in the SDRAM (28) from the external memory card (26) and the output of the audio file as the analog replay signal to the speaker (36) is defined as a replay.

The LED touch sensors (10), (20), (30), (40) provided on the top surface (9) include LEDs (10a), (20a), (30a), (40a) and sensors (10b), (20b), (30b), (40b), respectively. The sensors (10b), (20b), (30b), (40b) sense that the LED touch sensors (10), (20), (30), (40) have been touched by the user, causing the LEDs (10a), (20a), (30a), (40a) to emit light. Any one or more of the microphones (4), (5), (6), (7) positioned below a touched one or more of the LED touch sensors (10), (20), (30), (40) can be set as an audio pickup microphone, or can be switched to an OFF state (a state where the sound cannot be picked up, or where a picked-up analog audio signal is not output). The LEDs (10a), (20a), (30a), (40a) emit light if the microphones positioned below them are set as an audio pickup microphone.

The CPU (32) further includes a not-shown register therein, which stores flags (F10), (F20), (F30), (F40). The values of the flags (F10), (F20), (F30), (F40) correspond to light-emitting states of the LEDs (10a), (20a), (30a), (40a), respectively. When the LED is in a light-emitting state, the flag has a value of 1, and when the LED is not in a light-emitting state (is in a non-light-emitting state), the flag has a value of 0.

In this manner, an LED positioned above a microphone that is set as an audio pickup microphone emits light. Furthermore, when an LED touch sensor is touched, a microphone positioned below the LED touch sensor is set as an audio pickup microphone, or is switched to an OFF state. Accordingly, the user can set the state of a microphone by performing intuitive operation.

As described above, when the first housing (2) is rotated by the user, the IC recorder (1) is changed from the first state shown in FIGS. 1 and 2 to the second state shown in FIG. 3. The angle detection unit (38) detects an angle of rotation of the first housing (2), and detects an angle of movement of the microphone (4) from the first state where the microphone (4) and the microphone (5) are arranged vertically one above the other. The CPU (32) selects one of the plurality of audio recording modes described above in accordance with the detected angle. In the first state, an angle detected by the angle detection unit (38) is 0 degree. In the second state, an angle detected by the angle detection unit (38) is 90 degrees.

When a replay is started upon pressing of the replay button (42), the rotation of the first housing (2) corresponds to the rotation of a knob for adjusting the volume. When the first housing (2) is rotated, the volume of sound is changed depending on the angle of rotation of the first housing (2). The volume is at lowest level in the first state, and is at highest level in the second state. As the angle of rotation approaches 90 degrees with the counterclockwise rotation of the first housing (2), the volume level increases.

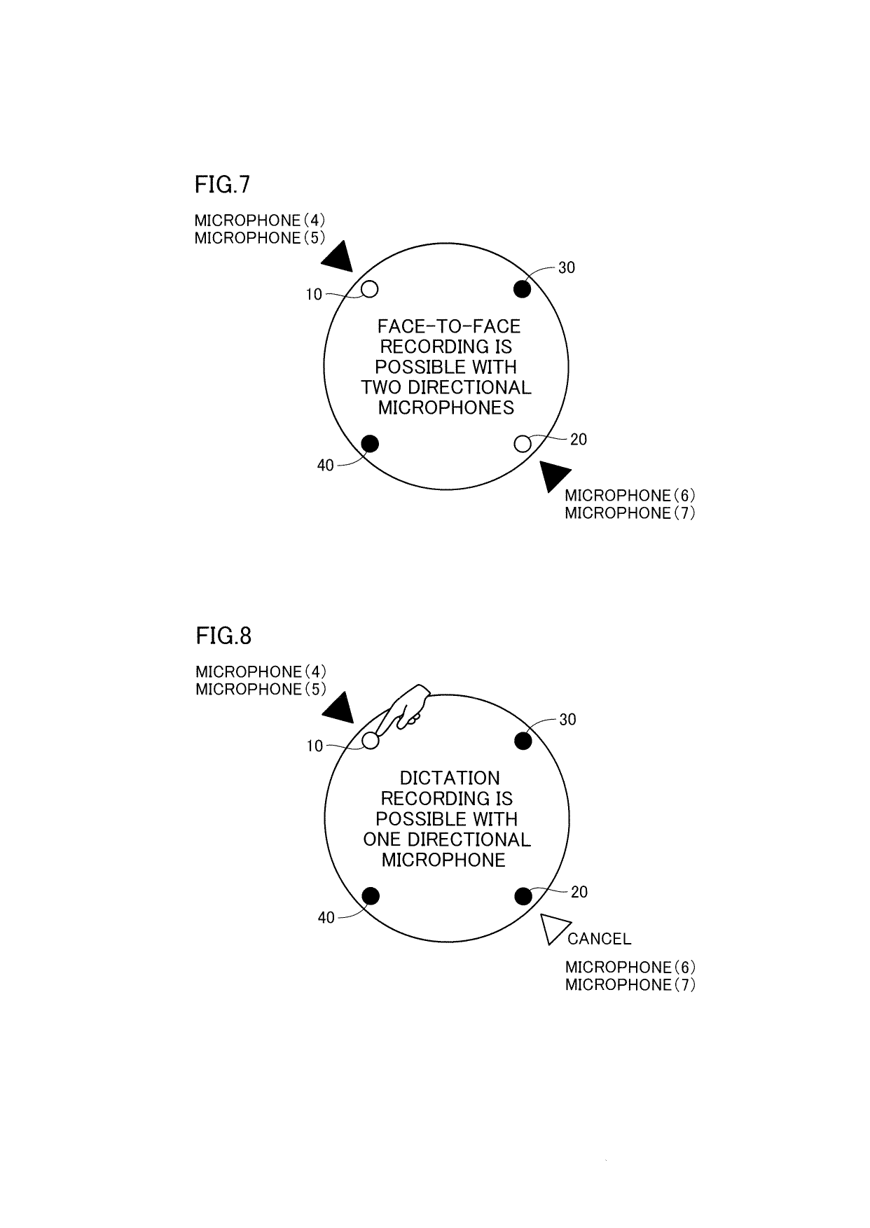

FIGS. 7 to 10 are simplified diagrams of the first housing (2), as seen from above the first housing (2), for explaining the states of the microphones (4), (5), (6), (7) that are set in accordance with the angle of rotation of the first housing (2) and the audio recording modes.

FIG. 7 shows the IC recorder (1) immediately after the application of power in the first state, or immediately after the first housing (2) was rotated to change from the second state to the first state. The microphones (4), (5) are positioned below the LED touch sensor (10), and the microphones (6), (7) are positioned below the LED touch sensor (20). Immediately after the application of power in the first state, or immediately after the change to the first state, all the microphones (4), (5), (6), (7) are set as audio pickup microphones. Only the LED touch sensors (10), (20) function (are enabled), while the LED touch sensors (30b), (40b) do not function (are disabled). The LEDs (10a), (20a) emit light, the conversation mode is automatically set as an audio recording mode, and the IC recorder (1) enters a standby state.

When the record button (44) is pressed by the user in this state, audio recording is started in the conversation mode. Specifically, as shown in FIG. 6, audio recording is started based on the sound picked up by the microphones (4), (5), (6), (7), with the ALC function being turned on, the microphone sensitivity being set low, the low cut filter function being turned on, the MP3 compression format with a bit rate of 128 kbps being employed as a recording mode, the VAS function being turned off, and the audio recording peak limiter function being turned off. When the stop button (46) is pressed, the audio recording ends, and the IC recorder (1) enters a standby state.

When the LED touch sensor (10) is touched by the user in the standby state, as shown in FIG. 8, light emission from the LED (20a) of the LED touch sensor (20) arranged diagonally to the LED touch sensor (10) is prohibited, the IC recorder (1) is set to the dictation mode, and the microphones (6), (7) are designated as noise canceling microphones. When the record button (44) is pressed in this state, audio recording is started in the dictation mode, with the noise canceling process.

Specifically, as shown in FIG. 6, audio recording is started based on the sound picked up by the microphones (4), (5), and the sound picked up by the microphones (6), (7) for noise canceling, with the ALC function being turned on, the microphone sensitivity being set low, the low cut filter function being turned on, the MP3 compression format with a bit rate of 64 kbps being employed as a recording mode, the VAS function being turned off, and the audio recording peak limiter function being turned off. When the stop button (46) is pressed, the audio recording ends, and the IC recorder (1) enters a standby state.

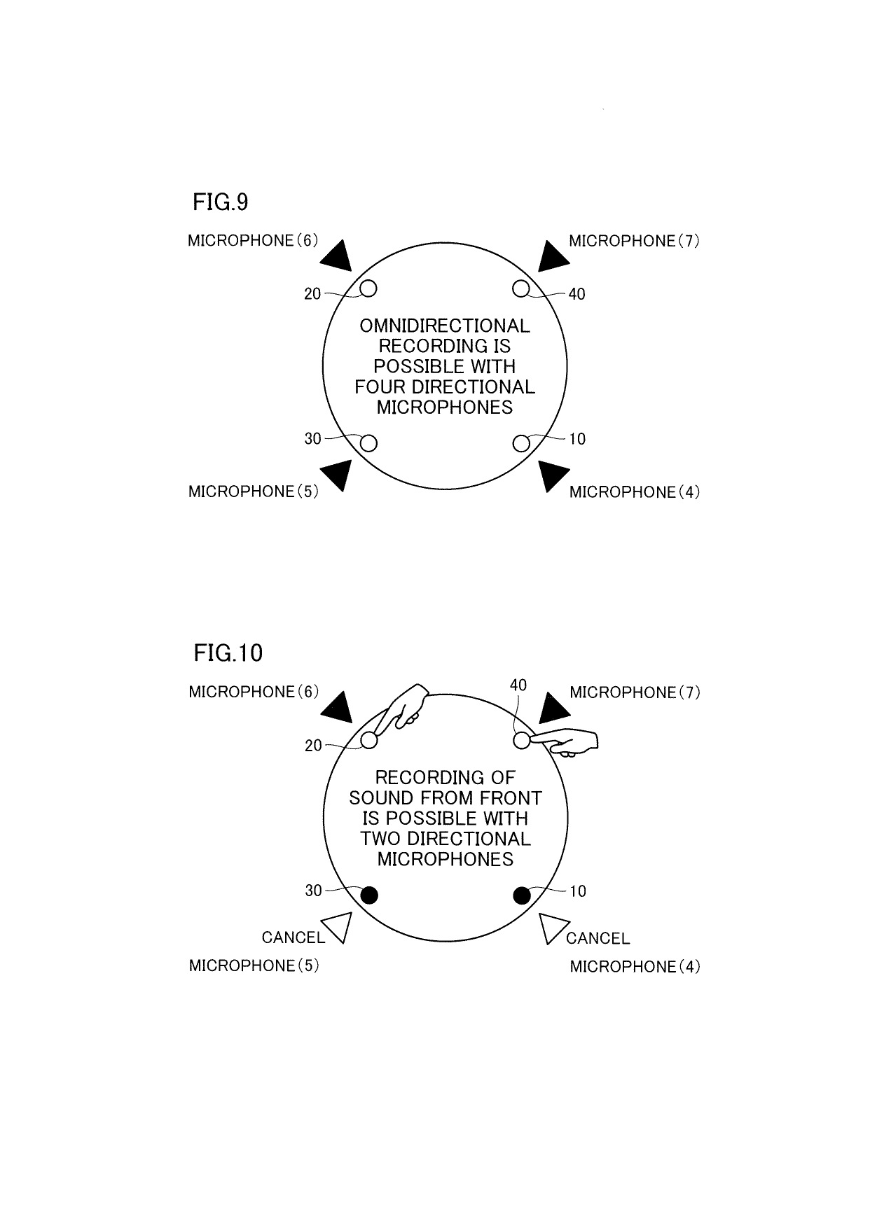

FIG. 9 shows the IC recorder (1) immediately after the application of power in the second state, or immediately after the first housing (2) was rotated to change from the first state to the second state. The microphone (4) is positioned below the LED touch sensor (10), the microphone (6) is positioned below the LED touch sensor (20), the microphone (5) is positioned below the LED touch sensor (30), and the microphone (7) is positioned below the LED touch sensor (40). Immediately after the application of power in the second state, or immediately after the change to the second state, all the microphones (4), (5), (6), (7) are set as audio pickup microphones, and all the LED touch sensors (10), (20), (30), (40) are enabled. The LEDs (10a), (20a), (30a), (40a) emit light, the conference mode is automatically set as an audio recording mode, and the IC recorder (1) enters a standby state.

When the record button (44) is pressed by the user in this state, audio recording is started in the conference mode. Specifically, as shown in FIG. 6, audio recording is started based on the sound picked up by the microphones (4), (5), (6), (7), with the ALC function being turned on, the microphone sensitivity being set high, the low cut filter function being turned on, the MP3 compression format with a bit rate of 128 kbps being employed as a recording mode, the VAS function being turned off, and the audio recording peak limiter function being turned off. When the stop button (46) is pressed, the audio recording ends, and the IC recorder (1) enters a standby state.

When the LED touch sensor (20) and the LED touch sensor (40) are touched by the user in the standby state, as shown in FIG. 10, light emission from the LED (10a) of the LED touch sensor (10) arranged diagonally to the LED touch sensor (20) is prohibited, and light emission from the LED (30a) of the LED touch sensor (30) arranged diagonally to the LED touch sensor (40) is prohibited. The microphones (4), (5) are designated as noise canceling microphones. When the record button (44) is pressed in this state, audio recording is started in the conference mode, with the noise canceling process.

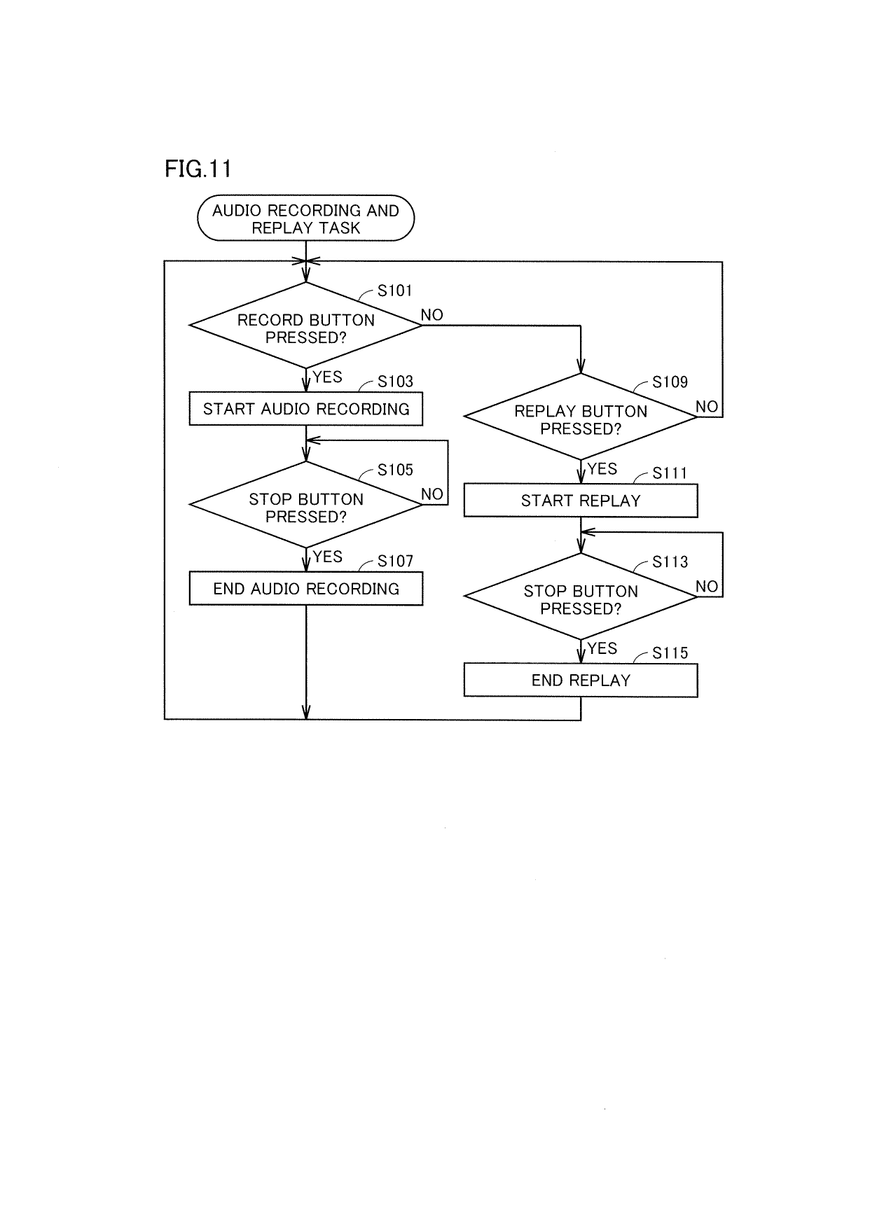

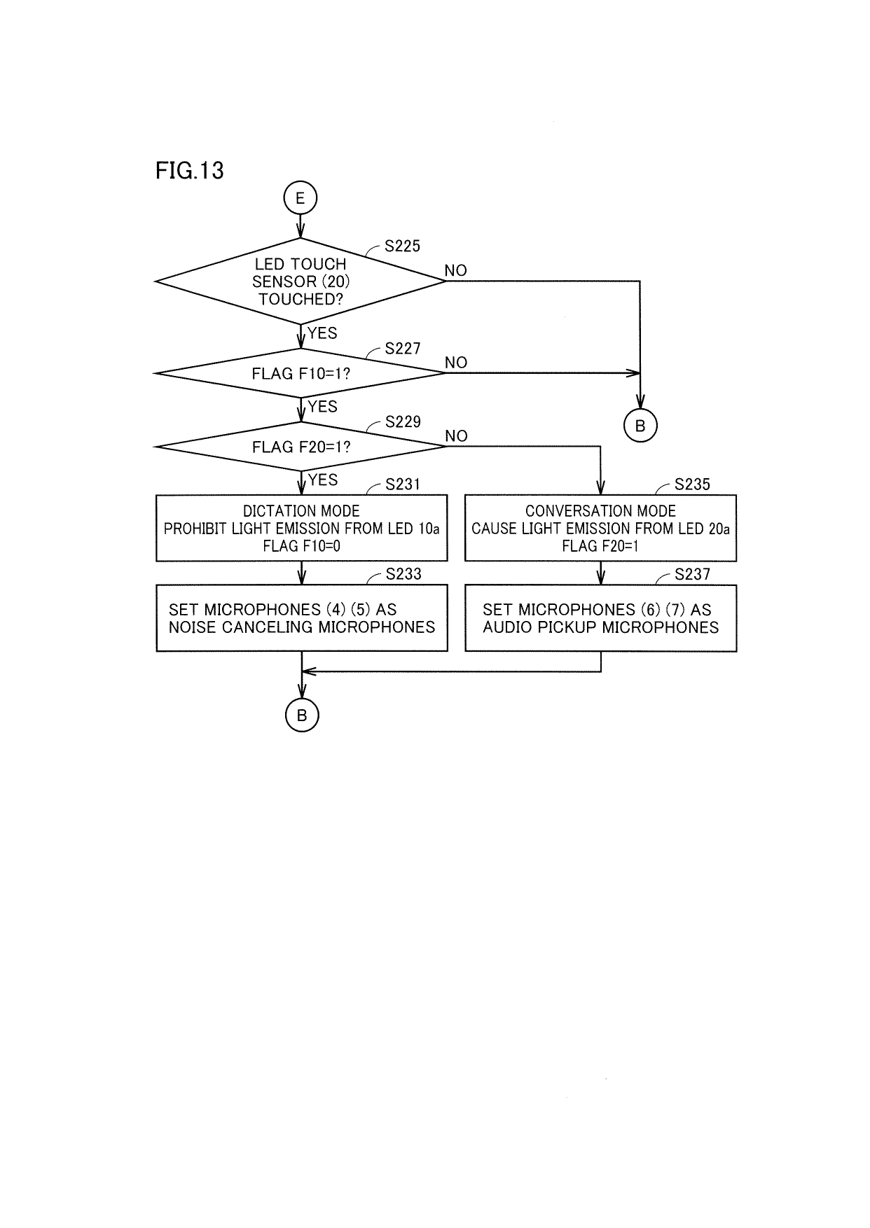

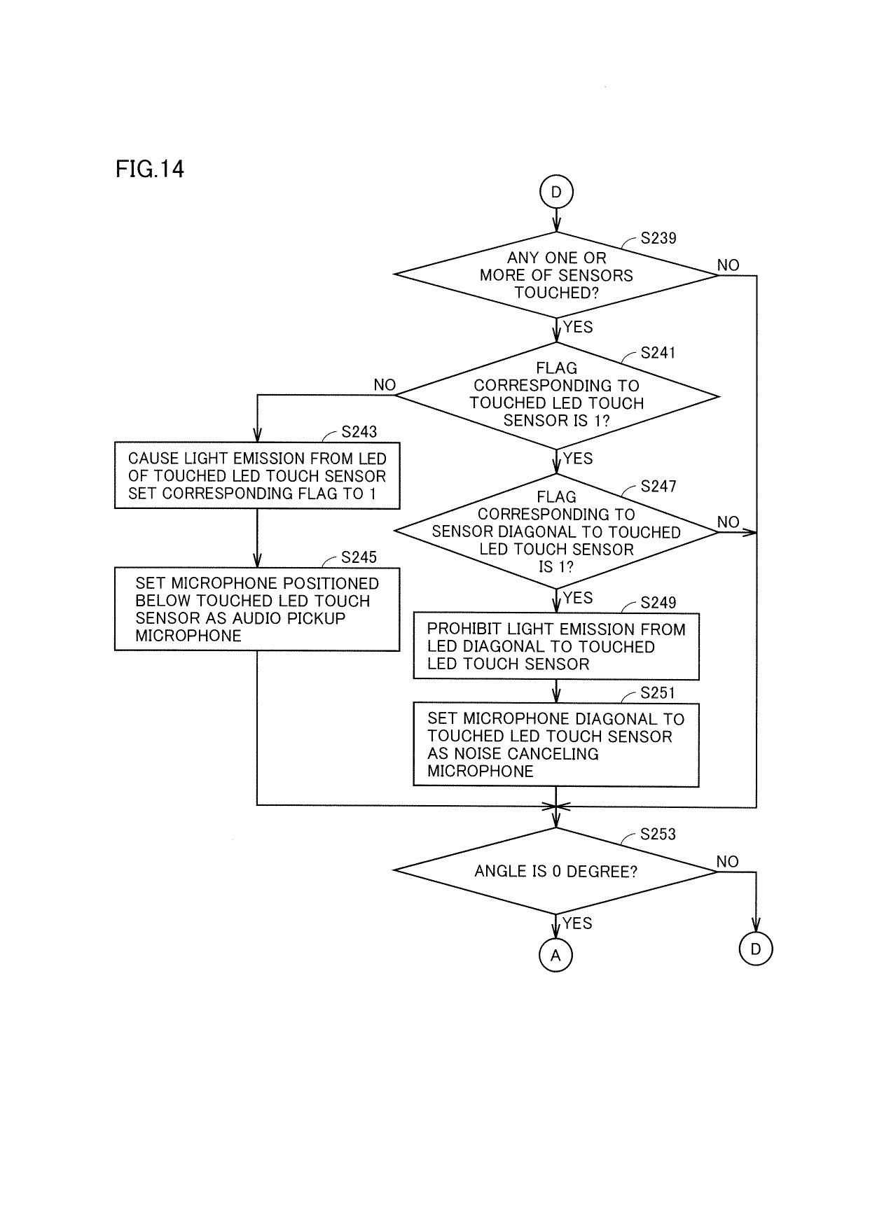

Referring now to flowcharts of an audio recording and replay task and a mode selection task as shown in FIGS. 11 to 14, the processes described above will be described. These processes are implemented when the CPU (32) executes the programs stored in the flash memory (18).

The audio recording and replay task is described first with reference to FIG. 11.

Upon application of power to the IC recorder (1), in step S101, the CPU (32) determines whether or not the record button (44) has been pressed. If it is YES in step S101, the process proceeds to step S103, where the CPU (32) controls each unit to start audio recording. The process then proceeds to step S105, where the CPU (32) determines whether or not the stop button (46) has been pressed. The CPU (32) repeats this determination until it is YES in step S105. If it is YES in step S105, the process proceeds to step S107, where the CPU (32) controls each unit to end the audio recording. The process then returns to step S101.

If it is NO in step S101, the process proceeds to step S109, where the CPU (32) determines whether or not the replay button (42) has been pressed. If it is NO in step S109, the process returns to step S101, whereas if it is YES, the process proceeds to step S111. A state where it is NO in step S101 and step S109 and the CPU (32) repeats the determination corresponds to the standby state.

In step S111, the CPU (32) controls each unit to start a replay. The process then proceeds to step S113, where the CPU (32) determines whether or not the stop button (46) has been pressed. The CPU (32) repeats this determination until it is YES in step S113. If it is YES in step S113, the process proceeds to step S115, where the CPU (32) controls each unit to end the replay. The process then returns to step S101.

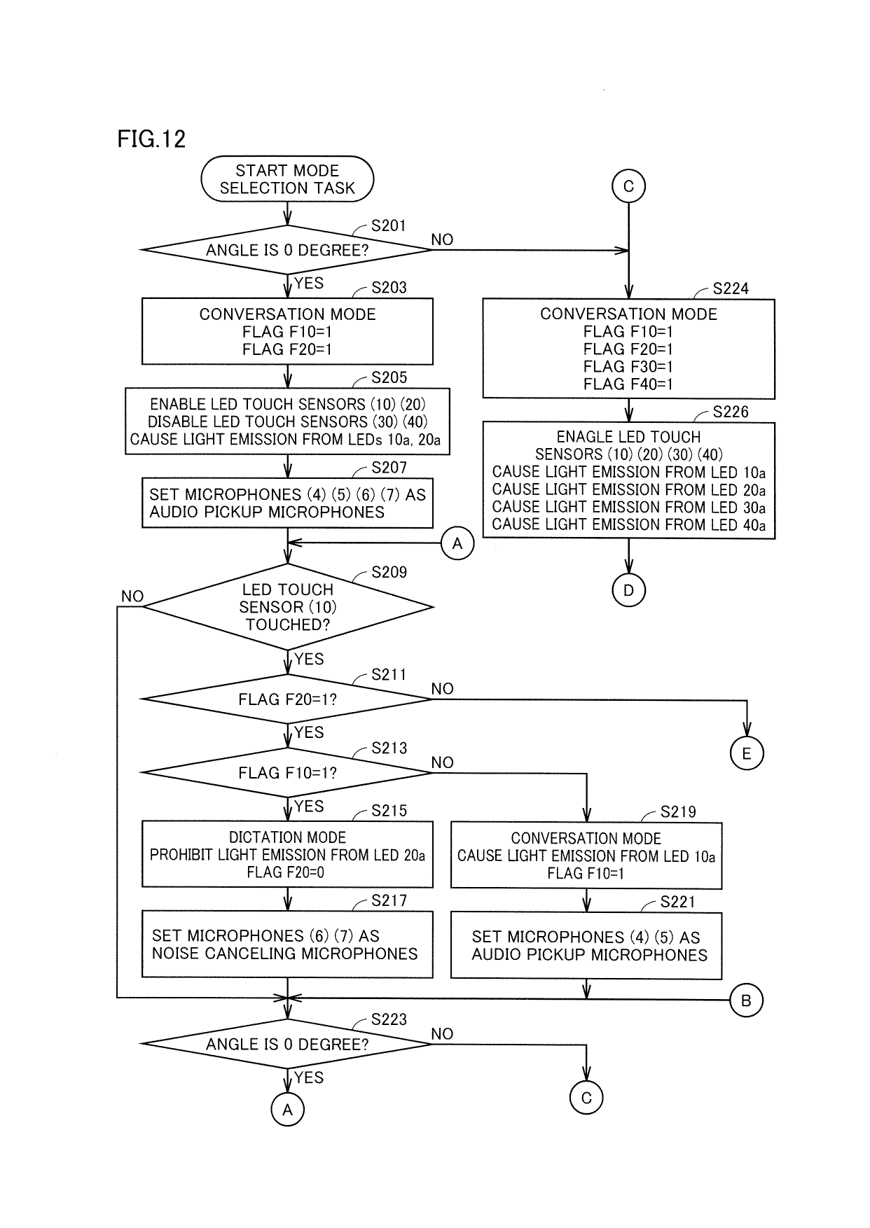

The mode selection task is described next with reference to FIGS. 12 to 14. The mode selection task is forcibly terminated if it is YES in step S101 or step S109 in the audio recording and replay task, and is executed upon application of power or when step S107 or step S115 ends.

In step S201, the CPU (32) determines whether or not an angle detected by the angle detection unit (38) is 0 degree. If it is YES in step S201, the process proceeds to step S203, where the CPU (32) sets the conversation mode, and sets the values of the flag (F10) and the flag (F20) to 1. The process then proceeds to step S205, where the CPU (32) enables the LED touch sensors (10), (20) and disables the LED touch sensors (30), (40), to cause light emission from the LEDs (10a), (20a). The process then proceeds to step S207, where the CPU (32) sets the microphones (4), (5), (6), (7) as audio pickup microphones.

The process then proceeds to step S209, where the CPU (32) determines whether or not the LED touch sensor (10) has been touched. If it is NO in step S209, the process proceeds to step S223, whereas if it is YES, the process proceeds to step S211. In step S211, the CPU (32) determines whether or not the value of the flag (F20) is 1. If it is NO in step S223, the process proceeds to step S225, whereas if it is YES, the process proceeds to step S213. In step S213, the CPU (32) determines whether or not the value of the flag (F10) is 1. If it is NO, the process proceeds to step S219. In step S219, the CPU (32) sets the conversation mode, causes light emission from the LED (10a), and sets the value of the flag (F10) to 1. The process then proceeds to step S221, where the CPU (32) sets the microphones (4), (5) as audio pickup microphones. The process then proceeds to step S223.

If it is YES in step S213, the process proceeds to step S215, where the CPU (32) prohibits light emission from the LED (20a), and sets the value of the flag (F20) to 0. The process then proceeds to step S217, where the CPU (32) sets the microphones (6), (7) as noise canceling microphones. The process then proceeds to step S223. In step S223, the CPU (32) determines whether or not an angle detected by the angle detection unit (38) is 0 degree. If it is YES in step S223, the process returns to step S209, whereas if it is NO, the process proceeds to step S224.

If it is NO in step S211, the process proceeds to step S225, where the CPU (32) determines whether or not the LED touch sensor (20) has been touched. If it is YES in step S225, the process proceeds to step S227, where the CPU (32) determines whether or not the value of the flag (F10) is 1. If it is YES in step S227, the process proceeds to step S229, where the CPU (32) determines whether or not the value of the flag (F20) is 1. If it is YES in step S229, the process proceeds to step S231, whereas if it is NO, the process proceeds to step S235. If it is NO in step S225 and step S227, the process proceeds to step S223.

In step S231, the CPU (32) sets the dictation mode as an audio recording mode, prohibits light emission from the LED (10a), and sets the value of the flag (F10) to 0. The process then proceeds to step S233, where the CPU (32) sets the microphones (4), (5) as noise canceling microphones. The process then proceeds to step S223.

In step S235, the CPU (32) sets the conversation mode as an audio recording mode, causes light emission from the LED (20a), and sets the value of the flag (F20) to 1. The process then proceeds to step S237, where the CPU (32) sets the microphones (6), (7) as audio pickup microphones. The process then proceeds to step S223.

If it is NO in step S201, and if it is NO in step S223, the process proceeds to step S224. In step S224, the CPU (32) sets the conference mode as an audio recording mode, and sets the values of the flags (F 10), (F20), (F30), (F40) to 1. The process then proceeds to step S226, where the CPU (32) enables the LED touch sensors (10), (20), (30), (40), and causes light emission from the LEDs (10a), (20a), (30a), (40a). The process then proceeds to step S239.

In step S239, the CPU (32) determines whether or not any one or more of the LED touch sensors (10), (20), (30), (40) has been touched. If it is NO in step S239, the process proceeds to step S253, whereas if it is YES, the process proceeds to step S241.

In step S241, the CPU (32) determines whether or not the value of a flag corresponding to the touched LED touch sensor is 1. In this step, if the touched LED touch sensor is the LED touch sensor (10), for example, the CPU (32) determines whether or not the value of the flag (F10) is 1. If it is NO in step S241, the process proceeds to step S243, where the CPU (32) causes light emission from an LED of the touched LED touch sensor, and sets the value of a flag corresponding to the touched LED touch sensor to 1. In this step, if the touched LED touch sensor is the LED touch sensor (10), for example, the CPU (32) causes light emission from the LED (10a), and sets the value of the flag (F10) to 1.

The process then proceeds to step S245, where the CPU (32) sets a microphone positioned below the touched LED touch sensor as an audio pickup microphone. In this step, if the touched LED touch sensor is the LED touch sensor (10), for example, the CPU (32) sets the microphone (4) as an audio pickup microphone.

If it is YES in step S241, the process proceeds to step S247, where the CPU (32) determines whether or not the value of a flag corresponding to an LED touch sensor arranged diagonally to the touched LED touch sensor is 1. In this step, if the touched LED touch sensor is the LED touch sensor (10), for example, the CPU (32) determines whether or not the value of the flag (F20) corresponding to the LED touch sensor (20) is 1.

If it is NO in step S247, the process proceeds to step S253, whereas if it is YES, the process proceeds to step S249. In step S249, the CPU (32) prohibits light emission from an LED of the LED touch sensor arranged diagonally to the touched LED touch sensor. In this step, if the touched LED touch sensor is the LED touch sensor (10), for example, the CPU (32) prohibits light emission from the LED (20a).

The process then proceeds to step S251, where the CPU (32) sets a microphone arranged diagonally to the touched LED touch sensor as a noise canceling microphone. In this step, if the touched LED touch sensor is the LED touch sensor (10), for example, the CPU (32) sets the microphone (6) as a noise canceling microphone. The process then proceeds to step S253, where the CPU (32) determines whether or not an angle detected by the angle detection unit (38) is 0 degree. If it is YES in step S253, the process returns to step S209, whereas if it is NO, the process returns to step S239.

In this embodiment, when an LED touch sensor with an LED in a light-emitting state is touched, a microphone arranged diagonally to the touched LED touch sensor is set as a noise canceling microphone. Alternatively, a microphone positioned below the sensor can be set as a noise canceling microphone. In this case, when the sensor (10b) is touched in the second state, for example, the microphone (4) may be set as a noise canceling microphone. When the sensor (10b) is touched, and if the microphone (4) has already been set as a noise canceling microphone, the microphone (4) is set as an audio pickup microphone.

When an LED touch sensor with an LED in a light-emitting state is touched, a microphone positioned below an LED touch sensor other than the touched LED touch sensor may be set as a noise canceling microphone. When the LED touch sensor (10) is touched in the second state, for example, the microphones (5), (6), (7) are set as noise canceling microphones. When the LED touch sensor (10) is touched, and if the microphone (4) has already been set as a noise canceling microphone, the microphone (4) is set as an audio pickup microphone.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 IC recorder; 2 first housing; 3 second housing; 4 microphone; 5 microphone; 6 microphone; 7 microphone; 9 top surface; 10 LED touch sensor; 20 LED touch sensor; 22 DSP; 30 LED touch sensor; 32 CPU; 36 speaker; 38 angle detection unit; 40 LED touch sensor; 42 replay button; 44 record button; 46 stop button.

1. An audio recorder comprising:
a first housing and a second housing which are arranged vertically one above the other, at least one of them being rotatably supported;
a plurality of microphones which include a first microphone and a second microphone provided in said first housing and said second housing, respectively; and
a control unit which sets a prescribed audio recording mode in accordance with a relative position of said first microphone and said second microphone, and enables an audio recording function in the set audio recording mode.

2. The audio recorder according to claim 1, wherein
said plurality of microphones include a third microphone provided in said first housing diagonally to said first microphone, and a fourth microphone provided in said second housing diagonally to said second microphone,
when at least one of said first housing and said second housing is rotated so that one of said first microphone and said third microphone and one of said second microphone and said fourth microphone are arranged vertically one above the other, said one of said first microphone and said third microphone and the other of said second microphone and said fourth microphone have directivities in opposite directions, and
when at least one of said first housing and said second housing is rotated so that a first diagonal line connecting said first microphone to said third microphone is substantially orthogonal to a second diagonal line connecting said second microphone to said fourth microphone, said first microphone, said second microphone, said third microphone and said fourth microphone have directivities in directions different from one another.

3. The audio recorder according to claim 2, wherein
said first microphone is arranged in the vicinity of a side surface of said first housing,
said audio recorder further comprises a first sensor provided on a top surface of said first housing, and in the vicinity of said first microphone, and
when detection is made by said first sensor, said control unit enables a function of turning off one of the microphones arranged diagonally to said first microphone, or reducing noise contained in an audio signal output from said first microphone based on an audio signal output from the diagonally arranged microphone.

4. The audio recorder according to claim 3, further comprising a third sensor and a fourth sensor provided on the top surface of said first housing, wherein
when at least one of said first housing and said second housing is rotated so that said second diagonal line is substantially orthogonal to said first diagonal line, said third sensor and said fourth sensor are provided on said second diagonal line,
when detection is made by said third sensor, said control unit enables a function of turning off one of the microphones arranged diagonally to one of the microphones arranged in the vicinity of said third sensor, or reducing noise contained in an audio signal output from the microphone arranged in the vicinity of said third sensor based on an audio signal output from the diagonally arranged microphone, and
when detection is made by said fourth sensor, said control unit enables a function of turning off one of the microphones arranged diagonally to one of the microphones arranged in the vicinity of said fourth sensor, or reducing noise contained in an audio signal output from the microphone arranged in the vicinity of said fourth sensor based on an audio signal output from the diagonally arranged microphone.

5. The audio recorder according to claim 1, further comprising a light-emitting unit provided on a top surface of said first housing, which indicates states of said plurality of microphones.

6. The audio recorder according to claim 1, further comprising a speaker provided on a top surface of said first housing, which outputs recorded sound in the vicinity of a rotation axis.
